(19) United States
(12) Patent Application Publication
(10) Pub. No.: US 2013/0308264 A1
(43) Pub. Date: Nov. 21, 2013

(54) HOLDING FRAME FOR HARD DISK DRIVES

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/719,986

(22) Filed: Dec. 19, 2012

(30) Foreign Application Priority Data
May 21, 2012 (CN) 201210157964.8

(51) Int. Cl. G11B 33/02

(52) U.S. Cl. CPC G11B 33/02
USPC 361/679.33

(57) ABSTRACT

A holding frame includes a holder body, a printed circuit board, a rotatable cover, and a subsidiary hard disk drive assembly. The rotatable cover is rotatably connected to the holder body. The subsidiary hard disk drive assembly is slidably attached to the rotatable cover, and faces the printed circuit board.

### BACKGROUND

1. Technical field

The disclosure generally relates to a holding frame for carrying a plurality of hard disk drives.

2. Description of the Related Art

Servers have a plurality of hard disk drives placed in a cabinet. The hard disk drives need a holding frame to be mounted in the server cabinet.

The holding frame usually includes a printed circuit board, and the hard disk drives are mounted on the holding frame and are adjacent to one side of the printed circuit board. However, the space above on the printed circuit board cannot be effectively utilized.

Therefore, there is room for improvement within the art.

### BRIEF DESCRIPTION OF THE DRAWINGS

Many aspects of an exemplary holding frame can be better understood with reference to the following drawings. The components in the drawings are not necessarily drawn to scale, the emphasis instead being placed upon clearly illustrating the principles of the exemplary holding frame. Moreover, in the drawings, like reference numerals designate corresponding parts throughout the several views. Wherever possible, the same reference numbers are used throughout the drawings to refer to the same or like elements of an embodiment.

FIG. 1 is a schematic view of a holding frame with a rotatable cover and a latching cover according to an exemplary embodiment.

FIG. 2 is a schematic view of the holding frame, showing the rotatable cover with a subsidiary hard disk drive assembly being opened relative to the latching cover.

FIG. 3 is an exploded view of the holding frame in FIG. 2.

FIG. 4 is an exploded view of the rotatable cover and the subsidiary hard disk drive assembly.

FIG. 5 is an assembled view of the subsidiary hard disk drive assembly.

FIG. 6 is an assembled view of the subsidiary hard disk drive assembly latched with the positioning members and the post and omitting the cover body of the rotatable cover.

### DETAILED DESCRIPTION

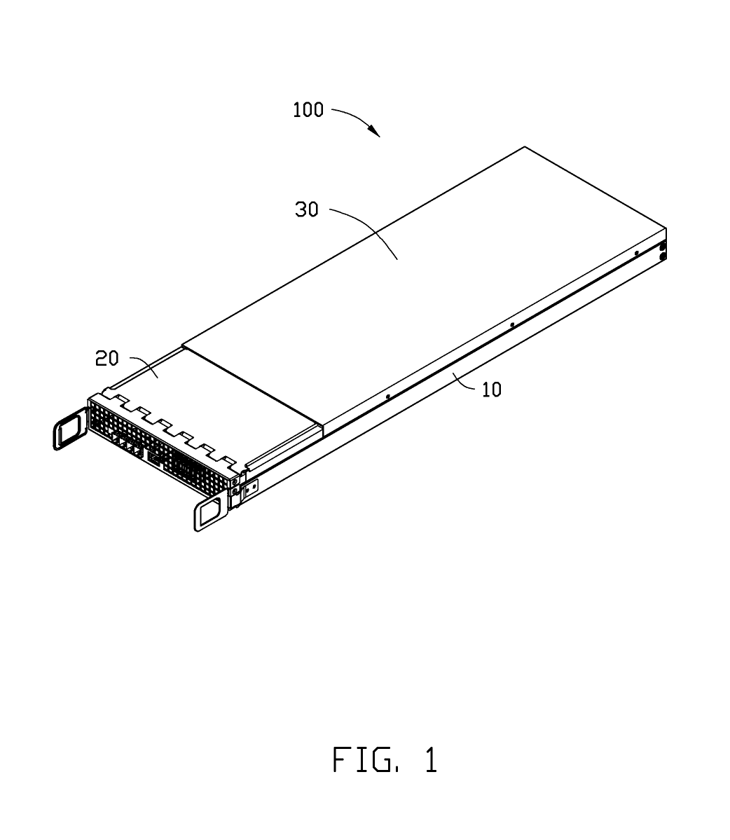

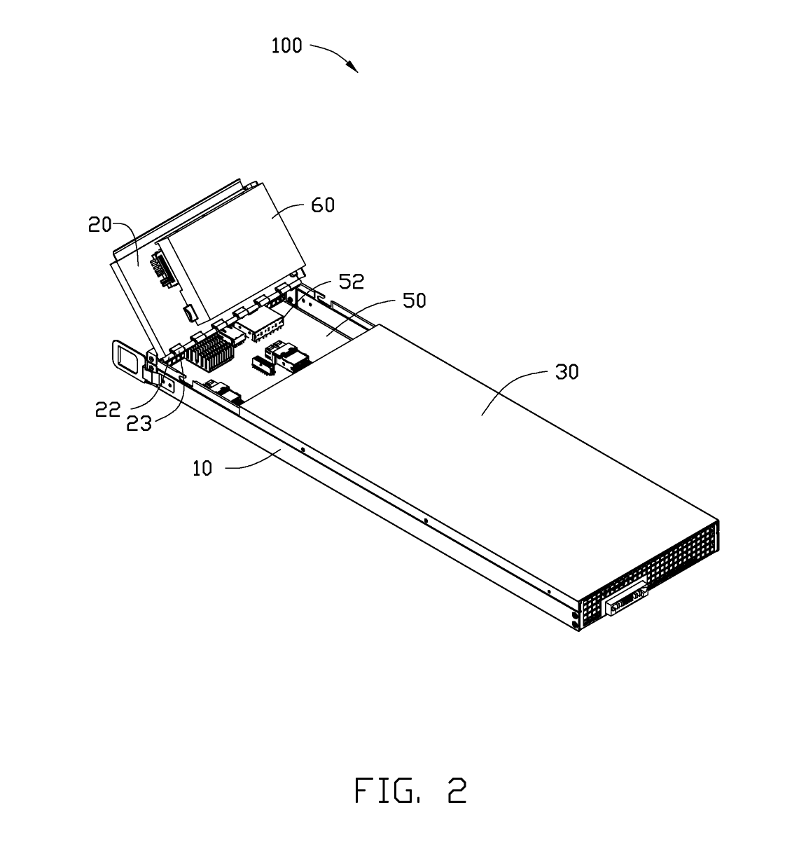

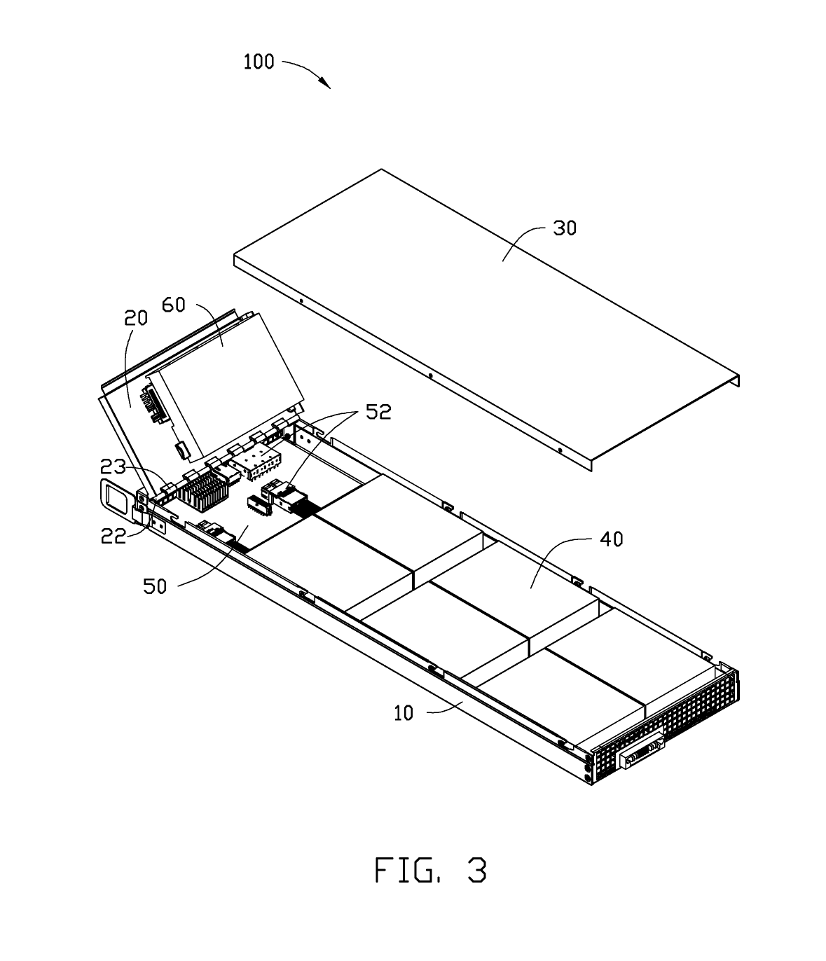

FIGS. 1 to 3 show an exemplary embodiment of a holding frame 100. The holding frame 100 is used in an electronic device such as a server. The holding frame 100 includes a holder body 10, a rotatable cover 20, and a latching cover 30. The rotatable cover 20 is rotatably connected to the holder body 10. A plurality of hard disk drives 40 are contained in the holder body 10. The rotatable cover 20 has a subsidiary hard disk drive assembly 60. A printed circuit board 50 is positioned on the holder body 10 and is adjacent to the hard disk drives 40. The printed circuit board 50 has many peripheral electronic components 52. The rotatable cover 20 is rotated to cover above the printed circuit board 50. The peripheral electronic components 52 have a lower height and can allow the subsidiary hard disk drive assembly 60 to be positioned thereabove. The latching cover 30 is detachably mounted on the holder body 10 for covering the hard disk drives 40.

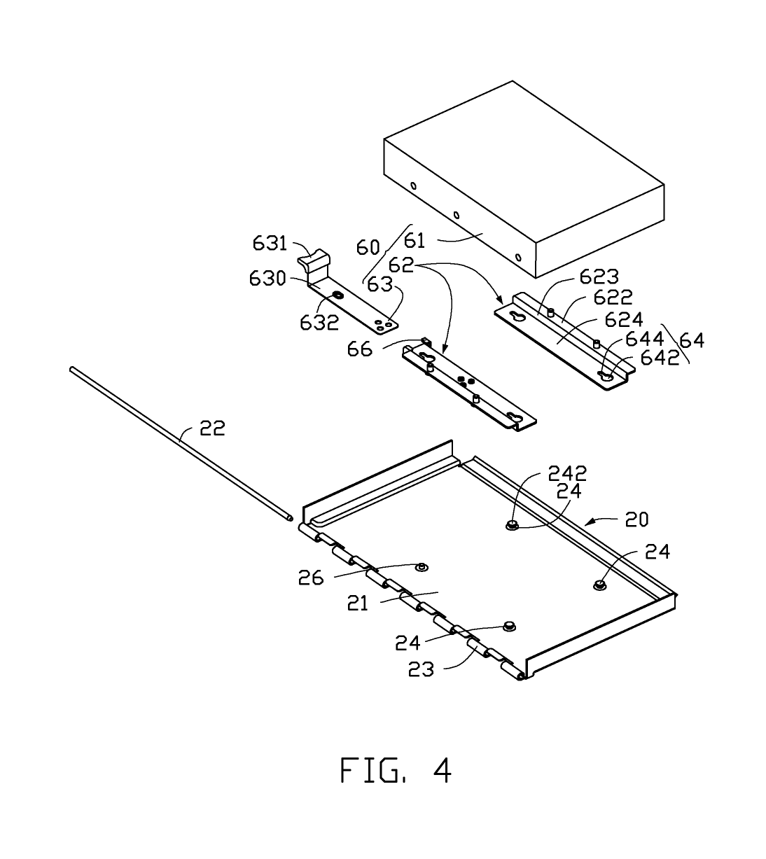

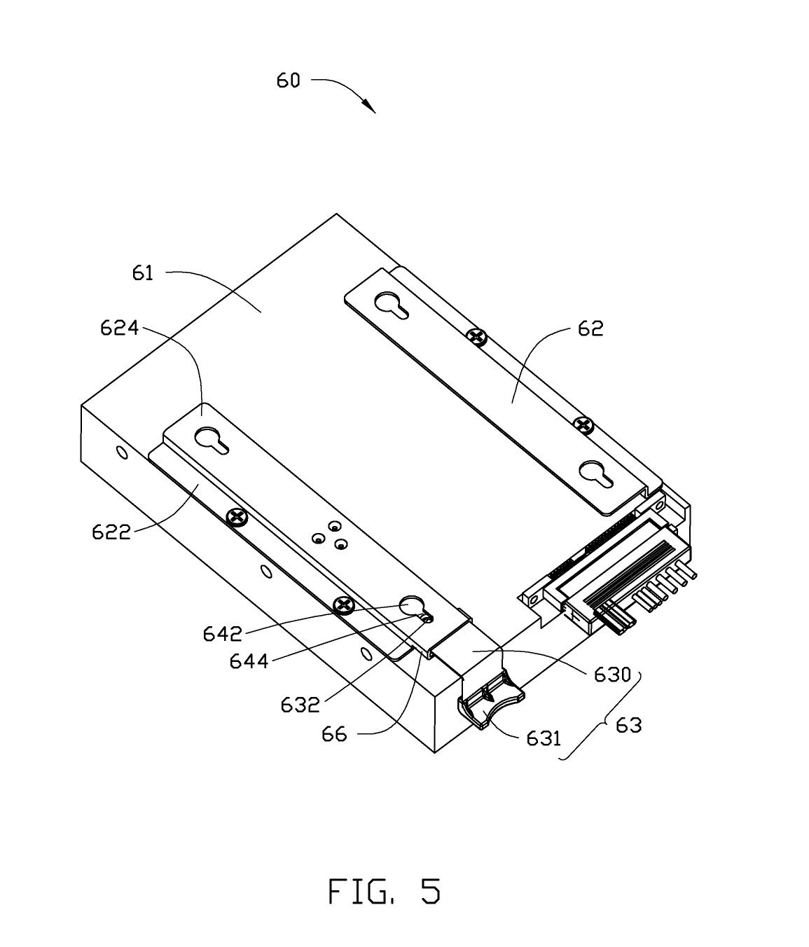

FIGS. 4 and 5 show that the rotatable cover 20 comprises a cover body 21, a pivotal shaft 22, a plurality of barrels 23, three positioning members 24, and a post 26. In this exemplary embodiment, the barrels 23 are formed at one side of the cover body 21 by punching. The barrels 23 are arranged along a line. The pivotal shaft 22 extends through the barrels 23, and two opposite ends of the pivotal shaft 22 are engaged with the holder body 10 for connecting the rotatable cover 20 to the holder body 10. The positioning members 24 and the post 26 extend from an inner surface of the cover body 21, that are are arranged along four corners of a rectangular. Each positioning member 24 has a cap 242.

The subsidiary hard disk drive assembly 60 is slidably attached to the rotatable cover 20 and faces the printed circuit board 50. The subsidiary hard disk drive assembly 60 comprises a subsidiary hard disk drive 61, two brackets 62, and a locking member 63. Each bracket 62 comprises a first extending plate 622, a second extending plate 624, and a connecting plate 623 that perpendicularly connecting the first extending plate 622 and the second extending plate 624. The first extending plate 622 is parallel to the second extending plate 624. The brackets 62 are positioned at opposite sides of one surface of the subsidiary hard disk drive 61. Each first extending plate 622 is mounted on the surface of the subsidiary hard disk drive 61 with fasteners. Each second extending plate 624 defines two receiving holes 64. The arrangement of the receiving holes 64 corresponds to the positioning members 24 and the post 26. The three positioning members 24 are slidably received in three of the receiving holes 64. The post 26 is slidably received the remaining receiving hole 64.

Each receiving hole 64 has a first hole 642 and a second hole 644, and the diameter of the first hole 642 larger than that of the second hole 644. The caps 242 prevent the positioning members 24 from separating from the second holes 644. One end of one of the brackets 62 has two hooks 66 extending toward each other. The locking member 63 is clamped between the hooks 66. The locking member 63 has a plate portion 630 and a pressed portion 631 perpendicularly connected to the plate portion 630. The plate portion 630 defines an aperture 632, that is configured for being aligned with the second hole 644 of one receiving hole 64. The post 26 is latched in the aperture 632

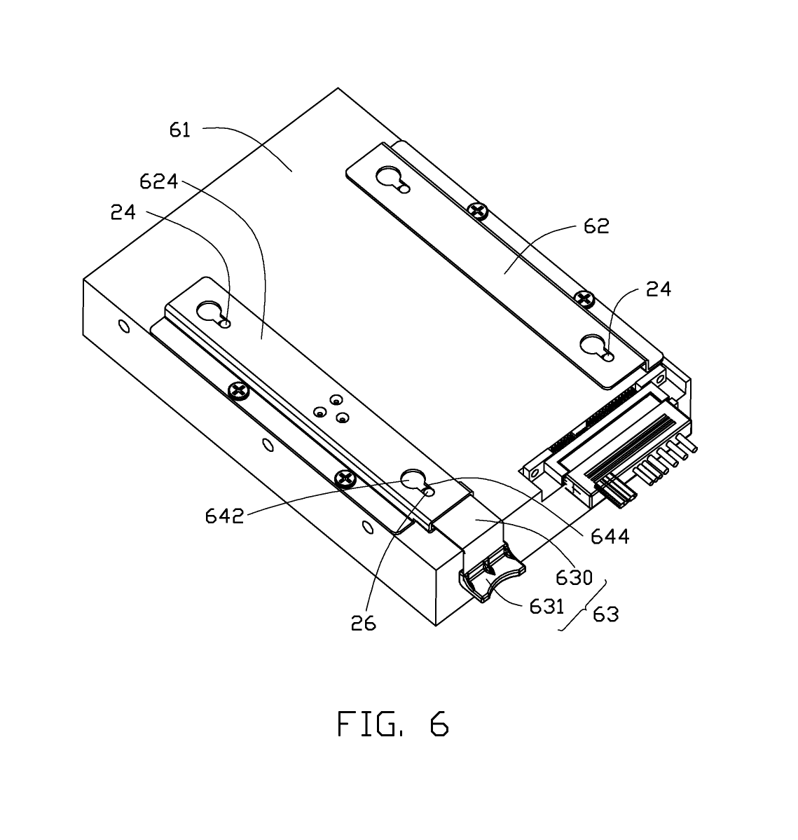

FIG. 6 further shows that during assembly, the first extending plates 622 are mounted on the subsidiary hard disk drive 61 with screws for attaching the brackets 62 on the subsidiary hard disk drive 61. The locking member 63 is connected to one of the brackets 62 with the hook 66. The pressed portion 631 is positioned at one end of the subsidiary hard disk drive 61. The plate portion 630 of the locking member 63 is positioned below the second extending plate 624 and is clamped between the hooks 66. The aperture 632 is aligned with the second hole 644 of the receiving hole 64. Thus, the assembly process of the subsidiary hard disk drive assembly 60 is finished.

The subsidiary hard disk drive assembly 60 faces the inner surface of the cover body 21. The positioning members 24 and the post 26 are received in the first holes 642 of the receiving holes 64. The subsidiary hard disk drive 61 is slid relative to the cover body 21 to allow the positioning members 24 and the post 26 to slide into the second holes 644. The pressed portion 631 of the locking member 63 is pressed to force a distal end of the post 26 to be received in the aperture 632 on the plate portion 630. The post 26 in the aperture 632 can prevent the positioning members 24 from moving in the receiving holes 64. Accordingly, the subsidiary hard disk drive 61 is positioned on the rotatable cover 20. After that, the assembled rotatable cover 20 is connected to the holder body 10 with the pivotal shaft 22, and is rotated to cover the printed circuit board 50.

If the subsidiary hard disk drive 61 needs to be replaced, the rotatable cover 20 only needs to be opened. The operation is very convenient. Additionally, the space above the printed circuit board 50 is sufficiently used.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A holding frame comprising:
a holder body;
a rotatable cover rotatably connected to the holder body; and
a subsidiary hard disk drive assembly slidably attached to the rotatable cover and facing an inside of the holder body.

2. The holding frame as claimed in claim 1, wherein the subsidiary hard disk drive assembly comprises a subsidiary hard disk drive and two brackets; each bracket comprises a first extending plate, a second extending plate, and a connecting plate, connecting the first extending plate and the second extending plate; and the first extending plates are mounted on the subsidiary hard disk drive.

3. The holding frame as claimed in claim 2, wherein each second extending plate defines a plurality of receiving holes, the rotatable cover has a plurality of positioning members slidably received in the plurality of receiving holes.

4. The holding frame as claimed in claim 3, wherein each receiving hole comprises a first hole and a second hole, and the diameter of the first hole is larger than that of the second hole.

5. The holding frame as claimed in claim 4, wherein the subsidiary hard disk drive assembly comprises a locking member that defines an aperture, the rotatable cover comprises a post, the post is slidably received in one of the receiving holes, and is located in the aperture.

6. A holding assembly comprising:
a holder body;
a rotatable cover rotatably connected to the holder body, the rotatable cover comprising at least one positioning member and a post; and
a subsidiary hard disk drive assembly comprising at least one bracket defining at least one receiving hole, the at least one positioning member slidably received in the at least one receiving hole, and the post latched in the at least one receiving hole for connecting the subsidiary hard disk drive assembly to the rotatable cover.

7. The holding assembly as claimed in claim 6, wherein the subsidiary hard disk drive assembly comprises a subsidiary hard disk drive; the at least one bracket comprises a first extending plate, a second extending plate, and a connecting plate connecting the first extending plate and the second extending plate; and the first extending plates are mounted on the subsidiary hard disk drive.

8. The holding assembly as claimed in claim 6, wherein each receiving hole comprises a first hole and a second hole, the diameter of the first hole larger than that of the second hole.

9. The holding assembly as claimed in claim 6, wherein the subsidiary hard disk drive assembly comprises a locking member defining an aperture, and the post is slidably received the at least one receiving hole and is latched in the aperture.
